(19) United States
(12) Patent Application Publication
(10) Pub. No.: US 2026/0254300 A1
(43) Pub. Date: Aug. 27, 2026

(54) YOKELESS MACHINE WITH INTEGRATED ROTOR

(71) Applicant: Gordon Abas GOODARZI, Rolling Hills, CA (US)

(72) Inventor: Gordon Abas GOODARZI, Rolling Hills, CA (US)

(21) Appl. No.: 19/062,806

(22) Filed: Feb. 25, 2025

(51) Int. Cl. H02K 1/2791; H02K 1/14

(52) U.S. Cl. CPC H02K 1/2791; H02K 1/14

(57) ABSTRACT

The electric machine may include a shaft having an axis of rotation. The electric machine may include an integrated rotor mechanically coupled with the shaft. The integrated rotor may include a first axial rotor component, a second axial rotor component, and a radial rotor component. The electric machine may include a yokeless stator assembly disposed between the first axial rotor component and the second axial rotor component. The yokeless stator assembly may be configured to magnetically interact with the first axial rotor component and the second axial rotor component. The electric machine may include a radial stator assembly. The radial stator assembly may include a radial stator component. The radial stator assembly may be configured to magnetically interact with the radial rotor component.

### TECHNICAL FIELD

Embodiments of the present invention generally relate to an electric machine, and more particularly to a yokeless electric machine.

### BACKGROUND

Electric machines, such as electric motors and electric generators, may be utilized to convert electrical energy into mechanical energy or vice versa. These electric motors play a crucial role in powering various applications, ranging from industrial equipment and transportation systems to household appliances and advanced robotics. Their efficiency and adaptability have made them useful in many practical applications.

Some systems face limitations in achieving high torque or power density. Increasing the electric machine size to enhance output often leads to greater weight and bulk, rendering it unsuitable for applications that demand compact and lightweight designs. Constraints on torque or power density can also affect the efficiency of the electric machine. Some systems can face challenges in maintaining efficiency across diverse operating conditions, including low-speed, high-torque scenarios and high-speed, low-torque demands. Such limitations are especially salient in electric vehicles (EVs) and robotics. Inefficiencies during field weakening or high-speed operations can result in energy losses, diminished performance, and/or restricted operational flexibility of the electric machines.

There is thus a need for more efficient and/or effective electric machines that may provide a solution to one or more of the aforementioned problems.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, wherein:

FIG. 1 is a cross-sectional view of an electric machine, according to at least one embodiment of the present invention.

FIG. 2 is a cross-sectional view of another electric machine, according to at least one embodiment of the present invention.

FIG. 3 is a cross-sectional view of an electric machine, according to at least one embodiment of the present invention.

FIG. 4 is an exploded view of an electric machine, according to at least one embodiment of the present invention.

FIG. 5 is a side view of a yokeless stator assembly, according to at least one embodiment of the present invention.

FIG. 6 is a cross-sectional view of an integrated rotor, according to at least one embodiment of the present invention.

FIG. 7 is an exploded view of a yokeless stator assembly, according to at least one embodiment of the present invention.

FIG. 8 is a side view of stator slots, according to at least one embodiment of the present invention.

FIG. 9 is a top view of the stator slots, according to at least one embodiment of the present invention.

FIG. 10 is an exemplary process for assembling an electric machine, according to at least one embodiment of the present invention.

FIG. 11 is an exemplary process for operating an electric machine, according to at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes”, “such as”, “for instance”, and “for example” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

An electric machine may include a shaft having an axis of rotation. The electric machine may further include an integrated rotor mechanically coupled with the shaft. The integrated rotor may include a first axial rotor component arranged substantially perpendicular to the axis of rotation, a second axial rotor component arranged substantially perpendicular to the axis of rotation and a radial rotor component arranged substantially parallel to the axis of rotation. The electric machine may further include a yokeless stator assembly disposed between the first axial rotor component and the second axial rotor component, the yokeless stator assembly configured to magnetically interact with the first axial rotor component and the second axial rotor component. The electric machine may further include a radial stator assembly that may include a radial stator component arranged substantially parallel to the axis of rotation. The radial stator assembly may be configured to magnetically interact with the radial rotor component.

An electric machine may include a shaft having an axis of rotation. The electric machine may further include an integrated yokeless rotor mechanically coupled with the shaft. The integrated yokeless rotor may include an axial rotor component arranged substantially perpendicular to the axis of rotation and a radial rotor component arranged substantially parallel to the axis of rotation. The electric machine may further include a first axial stator assembly arranged substantially perpendicular to the axis of rotation; the first axial stator assembly configured to magnetically interact with the axial rotor component. The electric machine may further include a second axial stator assembly arranged substantially perpendicular to the axis of rotation; the second axial stator assembly configured to magnetically interact with the axial rotor component. The axial rotor component may be disposed between the first axial stator assembly and the second axial stator assembly. The electric machine may further include a radial stator assembly. The radial stator assembly may further include a radial stator component arranged substantially parallel to the axis of rotation. The radial stator assembly may be configured to magnetically interact with the radial rotor component.

An apparatus may include a shaft having an axis of rotation. The apparatus may further include an integrated rotor mechanically coupled with the shaft. The integrated rotor may include at least one axial rotor component arranged substantially perpendicular to the axis of rotation and a radial rotor component arranged substantially parallel to the axis of rotation. The at least one axial rotor component may be mechanically integrated with the radial rotor component such that the at least one axial rotor component and the radial rotor component have a common angular velocity. The apparatus may further include a stator assembly configured at least to magnetically interact with the at least one axial rotor component and the radial rotor component.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input if the input is received before the performance of the process or operation. Human input may deemed to be material if such input influences how the process or operation is performed. As an example, human input that merely consents to the performance of the process or operation may be deemed to be immaterial.

The term “rotor” and variations thereof, as used herein, may refer to a rotating component of an electric machine.

The term “stator” and variations thereof, as used herein, may refer to a stationary component of the electric machine.

The term “magnetic flux” and variations thereof, as used herein, may refer to magnetic field passing through a specified area.

The term “magnetic field” and variations thereof, as used herein, may refer to the region of influence around a magnetic material or an electric current-carrying conductor where magnetic forces are exerted.

The term “air gap” and variations thereof, as used herein, may refer to a physical clearance or spacing between a rotor and a stator in an electric machine.

The term “windings” and variations thereof, as used herein, may refer to conductive elements, typically made of materials such as copper or aluminum, that may be positioned on the stator, rotor, or both. These windings may generate and/or interact with magnetic fields when electrical current passes through them.

The term “poles” and variations thereof, as used herein, may refer to regions of the magnetic field within the rotor, stator, or both, that possess distinct magnetic polarities (e.g., North and South). Poles may be created through the arrangement of windings or permanent magnets and significantly influence the torque production, speed characteristics, and operational efficiency of the electric machine.

The term “axis” and variations thereof, as used herein, may refer to a central line or an axis of rotation of the rotor within the electric machine. The axis may provide a reference for aligning components, defining rotational dynamics, and/or establishing an optimal electromagnetic interaction between a rotor and a stator.

Although various embodiments are described with respect to an electric machine in a role as a motor and/or generator, it may be contemplated that the approaches of the various embodiments described herein are applicable to high torque electric machines for any suitable industrial application as required or recommended.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

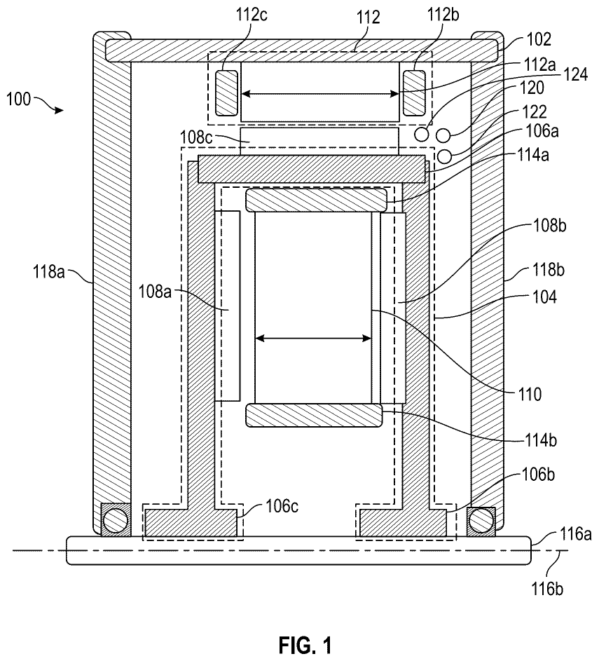

FIG. 1 depicts a cross-sectional view of an electric machine 100, according to at least one embodiment of the present invention. The electric machine 100 may be adapted to generate mechanical power through a conversion of electrical energy.

In an exemplary scenario of the present invention, the electric machine 100 may include an energy converter, for example, a motor, that may be adapted to convert electrical energy into mechanical power. Alternatively, or in addition, the electric machine 100 may act as a generator, to convert mechanical power into electrical energy.

In a further scenario of the present invention, the electric machine 100 may include energy transformers that may be adapted to convert the electrical energy between different forms. The electric machine 100 may be adapted to convert energy for regulation of output power to match demands of specific applications. The electric machine 100 may be adapted to deliver high torque at low speed for industrial applications. The electric machine 100 may be adapted to reduce output torque ripple and input current ripple, according to the embodiments of the present invention. Embodiments of the present invention may be intended to include or otherwise cover any suitable functionality of the electric machine 100, including known, related art, and/or later developed technologies.

The electric machine 100 may incorporate one or more features of, for example, a brushless Direct Current (DC) motor, a synchronous motor, a wound rotor induction motor, a stepper motor, a switched reluctance motor, a linear motor, a high-speed turbine generator, a reluctance synchronous motor, an axial flux motor, a hybrid stepper motor, a permanent magnet synchronous motor, an asynchronous motor, a doubly-fed induction generator, a permanent magnet motor, a radial flux motor, a flux-switching motor, a synchronous reluctance motor, a linear induction motor, a DC series motor, a DC shunt motor, a universal motor, a trapezoidal permanent magnet motor, a hysteresis motor, a crossed field motor, a segmented rotor motor, a variable reluctance motor, a low-speed high-torque motor, a piezoelectric motor, a ferrofluidic motor, transformers and so forth. Embodiments of the present invention may be intended to include or otherwise cover any suitable type of the electric machine 100, including known, related art, and/or later developed technologies.

According to embodiments of the present invention, the electric machine 100 may include an external housing 102. The external housing 102 may be adapted to enclose and protect internal components of the electric machine 100. The external housing 102 may further be adapted to dissipate heat generated during an operation and to provide a structural support for mounting the electric machine 100 in various applications. The external housing 102 may be adapted to prevent the ingress of contaminants, such as dust and moisture, thereby enhancing the durability and reliability of the electric machine 100.

According to embodiments of the present invention, the electric machine 100 may include an integrated rotor 104. The integrated rotor 104 may be mechanically coupled with a shaft 116a. The integrated rotor 104 may include a radial rotor component 106a. The integrated rotor 104 may further include a first axial rotor component 106b and a second axial rotor component 106c. According to the embodiments of the present invention, the radial rotor component 106a, the first axial rotor component 106b, and the second axial rotor component 106c of the integrated rotor 104 may be configured to magnetically interact with stator assemblies.

In an embodiment of the present invention, the radial rotor component 106a may be arranged substantially parallel to an axis of rotation 116b. The first axial rotor component 106b, and the second axial rotor component 106c may be arranged substantially perpendicular to the axis of rotation 116b. The first axial rotor component 106b, and the second axial rotor component 106c may be arranged at an angle such as, less than 0.5 degrees, less than 1.0 degrees, less than 2 degrees, less than 5 degrees, less than 10 degrees, less than 20 degrees, less than 45 degrees, less than 60 degrees, and so forth from the perpendicular. Embodiments of the present invention are intended to include or otherwise cover any suitable angle for arrangement of the first axial rotor component 106b, and the second axial rotor component 106c with the axis of rotation 116b. The first axial rotor component 106b and the second axial rotor component 106c may be arranged at a first angle and at a second angle, respectively, with respect to the axis of rotation 116b. In at least one embodiment of the present invention, the first angle and the second angle may be greater than 0 degrees and less than 60 degrees. Embodiments of the present invention may be intended to include or otherwise cover any suitable magnitude of the first angle and the second angle.

The integrated rotor 104 may further include a plurality of stator poles 108a-108b (hereinafter collectively referred to as the stator poles 108, or individually referred to as the first stator pole 108a, and the second stator pole 108b), and a radial magnet 108c. The first stator pole 108a may be arranged corresponding to the first axial rotor component 106b of the integrated rotor 104. The second stator pole 108b may be arranged corresponding to the second axial rotor component 106c of the integrated rotor 104.

The radial magnet 108c may be arranged corresponding to the radial rotor component 106a of the integrated rotor 104. The stator poles 108 and the radial magnet 108c may be configured to generate magnetic fields in radial and/or axial directions. The stator poles 108 and the radial magnet 108c may be constructed of any magnetic substance such as a bipolar magnetic substance, a ferromagnetic substance, a ferrous magnetic substance, and so forth. In at least one embodiment of the present invention, the stator poles 108 and the radial magnet 108c may be constructed of rare earth magnet material. Embodiments of the present invention may be intended to include or otherwise cover any suitable type of the magnetic substance, including known, related art, and/or later developed technologies, for construction of the stator poles 108 and the radial magnet 108c. The rare earth magnet material may be Neodymium, Samarium Cobalt, Dysprosium, Ceramic, Alnico, and so forth. Embodiments of the present invention may be intended to include or otherwise cover any suitable type of the rare earth magnet material, including known, related art, and/or later developed technologies.

The integrated rotor 104 may be disposed with respect to a yokeless stator assembly 110 and a radial stator assembly 112, in a predefined configuration that may define a relative positioning of the integrated rotor 104 with the yokeless stator assembly 110 and the radial stator assembly 112.

In an embodiment of the present invention, as shown in the FIG. 1, the predefined configuration may include an inner rotating configuration of the integrated rotor 104. For example, the integrated rotor 104 may be disposed between the yokeless stator assembly 110 and the radial stator assembly 112. The yokeless stator assembly 110 and a radial stator component 112a of the radial stator assembly 112 may be adapted to magnetically interact with the integrated rotor 104.

The yokeless stator assembly 110 may be disposed between the first axial rotor component 106b and the second axial rotor component 106c. The yokeless stator assembly 110 may be configured to magnetically interact with the first axial rotor component 106b and the second axial rotor component 106c. The yokeless stator assembly 110 may include a plurality of windings 114a-114b that may generate the magnetic fields.

The radial stator assembly 112 may be configured to magnetically interact with the radial rotor component 106a. The integrated rotor 104 may be disposed between the radial stator component 112a and the yokeless stator assembly 110. The radial stator component 112a may be positioned continuously and/or discontinuously around the integrated rotor 104. The radial stator component 112a may include stator windings 112b-112c that may generate the magnetic fields.

The integrated rotor 104 may be mechanically coupled with the shaft 116a (also referred to as a central shaft) for transmitting rotational motion. The shaft 116a may act as a central axis for rotations of the integrated rotor 104. The shaft 116a may include the axis of rotation 116b. The shaft 116a may be arranged to support the integrated rotor 104 and to transmit mechanical power to an external system powered through the electric machine 100. In an exemplary scenario of the present invention, the integrated rotor 104 may be mechanically coupled with the shaft 116a through bearings (not shown). Embodiments of the present invention may be intended to include or otherwise cover any suitable type of the mechanical coupling for the integrated rotor 104 and the shaft 116a, including known, related art, and/or later developed technologies.

According to at least one embodiment of the present invention, the electric machine 100 may further include end bell 118a-118b. The end bell 118a-118b may be adapted to enclose and support one or both ends of the external housing 102. The end bell 118a-118b may further be adapted to provide structural integrity to the electric machine 100 and house components such as the bearings for supporting the shaft 116a. The end bell 118a-118b may be adapted to facilitate an alignment of the integrated rotor 104 with the yokeless stator assembly 110 and the radial stator assembly 112. The end bell 118a-118b may enable a proper sealing to prevent the ingress of contaminants, such as dust or moisture. In an exemplary embodiment of the present invention, the end bell 118a-118b may include ventilation and/or openings and/or channels and/or mechanisms to aid in cooling internal components of the electric machine 100. Embodiments of the present invention may be intended to include or otherwise cover any suitable design and/or configuration of the end bell 118a-118b, including known, related art, and/or later developed technologies.

According to at least one embodiment of the present invention, the electric machine 100 may further include a radial controller 120, an axial controller 122, and a unified controller 124.

The radial controller 120 may be configured to control at least one electrical parameter of the radial stator component 112a. The axial controller 122 may be configured to control at least one electrical parameter of the yokeless stator assembly 110. The unified controller 124 may be configured to control at least one electrical parameter of the radial stator component 112a and the yokeless stator assembly 110. The unified controller 124 may further be configured to control the at least one electrical parameter based at least in part on a measured value of the at least one electrical parameter. The unified controller 124 may supervise the radial controller 120 and the axial controller 122. Alternatively, or in addition, the unified controller 124 may incorporate the radial controller 120 and the axial controller 122.

The electrical parameters may be for example, a rotational speed of the integrated rotor 104, the torque of the electric machine 100, a load condition of the electric machine 100, a current, a voltage, an electric flux, the magnetic flux, and so forth. Embodiments of the present invention may be intended to include or otherwise cover any suitable electrical parameters, including known, related art, and/or later developed technologies, that may be controlled by the radial controller 120, the axial controller 122, and the unified controller 124.

The radial controller 120, the axial controller 122, and the unified controller 124 may be a Programmable Logic Control (PLC) unit, a microprocessor, a development board, and so forth. Embodiments of the present invention may be intended to include or otherwise cover any suitable type of the radial controller 120, the axial controller 122, and the unified controller 124, including known, related art, and/or later developed technologies.

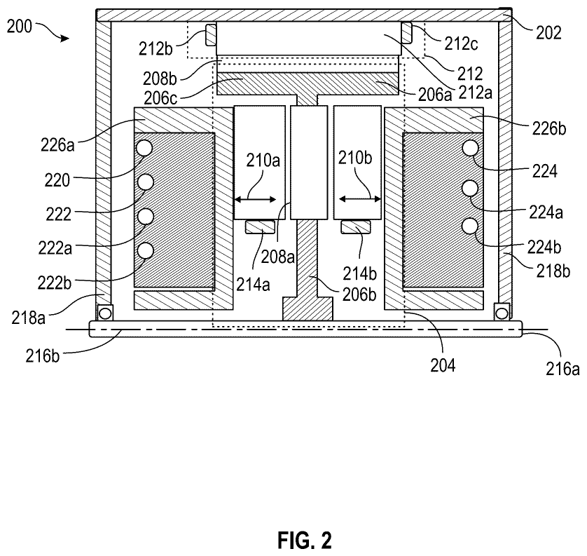

FIG. 2 depicts a cross-sectional view of an electric machine 200, according to at least one embodiment of the present invention. The electric machine 200 (FIG. 2) may be an example of the electric machine 100 (FIG. 1). According to embodiments of the present invention, the electric machine 200 may include an external housing 202. The external housing 202 (FIG. 2) may be an example of the external housing 102 (FIG. 1).

According to embodiments of the present invention, the electric machine 200 may include an integrated yokeless rotor 204. The integrated yokeless rotor 204 may include a first radial rotor component 206a and a second radial rotor component 206c. The integrated yokeless rotor 204 may further include an axial rotor component 206b.

According to the embodiments of the present invention, the first radial rotor component 206a, the axial rotor component 206b, and the second radial rotor component 206c of the integrated yokeless rotor 204 may be configured to magnetically interact with the stator assemblies. In an embodiment of the present invention, the first radial rotor component 206a and the second radial rotor component 206c may be arranged substantially parallel to the axis of rotation 216b. The first radial rotor component 206a and the second radial rotor component 206c may be arranged at an angle such as, but not limited to, less than 0.5 degrees, less than 1.0 degrees, less than 2 degrees, less than 5 degrees, less than 10 degrees, less than 20 degrees, less than 45 degrees, less than 60 degrees, and so forth parallel to the axis of rotation 216b. Embodiments of the present invention are intended to include or otherwise cover any suitable angle for arrangement of the first radial rotor component 206a and the second radial rotor component 206c with the axis of rotation 216b. The first radial rotor component 206a and the second radial rotor component 206c may be arranged at the first angle and at the second angle, respectively, with respect to the axis of rotation 216b. In at least one embodiment of the present invention, the first angle and the second angle may be greater than 0 degrees and less than 60 degrees. Embodiments of the present invention may be intended to include or otherwise cover any suitable magnitude of the first angle and the second angle.

The integrated yokeless rotor 204 may further include a stator pole 208a and a radial magnet 208b. The stator pole 208a (FIG. 2) may be an example of the first stator pole 108a (FIG. 1) and the second stator pole 108b (FIG. 1). The radial magnet 208b (FIG. 2) may be an example of the radial magnet 108c (FIG. 1). The stator pole 208a may be arranged corresponding to the axial rotor component 206b of the integrated yokeless rotor 204. The radial magnet 208b may be arranged corresponding to the first radial rotor component 206a and the second radial rotor component 206c of the integrated yokeless rotor 204.

The integrated yokeless rotor 204 may be disposed with respect to a first axial stator assembly 210a, a second axial stator assembly 210b, and to a radial stator assembly 212, in a predefined configuration that defines the relative positioning of the integrated yokeless rotor 204 with the first axial stator assembly 210a, the second axial stator assembly 210b, and the radial stator assembly 212. The radial stator assembly 212 (FIG. 2) may be an example of the radial stator assembly 112 (FIG. 1).

In an embodiment of the present invention, as shown in the FIG. 2, the predefined configuration may include the inner rotating configuration of the integrated yokeless rotor 204. The first axial stator assembly 210a, the second axial stator assembly 210b, and a radial stator component 212a of the radial stator assembly 212 may be adapted to magnetically interact with the integrated yokeless rotor 204. The radial stator component 212a (FIG. 2) may be an example of the radial stator component 112a (FIG. 1).

The first axial stator assembly 210a and the second axial stator assembly 210b may be disposed between the axial rotor component 206b. The first axial stator assembly 210a and the second axial stator assembly 210b may be configured to magnetically interact with the axial rotor component 206b. The first axial stator assembly 210a and the second axial stator assembly 210b may be arranged substantially perpendicular to an axis of rotation 216b.

The first axial stator assembly 210a and the second axial stator assembly 210b may include a plurality of windings 214a-214b that may generate the magnetic fields. The plurality of windings 214a-214b (FIG. 2) may be an example of the plurality of windings 114a-114b (FIG. 1).

The radial stator assembly 212 may be configured to magnetically interact with the first radial rotor component 206a and the second radial rotor component 206c. The integrated yokeless rotor 204 may be disposed between the radial stator component 212a, the first axial stator assembly 210a, and the second axial stator assembly 210b. The radial stator component 212a may be positioned continuously and/or discontinuously around the integrated yokeless rotor 204. The radial stator component 212a may be arranged substantially parallel to the axis of rotation 216b. The radial stator component 212a may include stator windings 212b-212c that may generate the magnetic fields.

The integrated yokeless rotor 204 may further be mechanically coupled with a shaft 216a for transmitting rotational motion. The shaft 216a (FIG. 2) may be an example of the shaft 116a (FIG. 1). The shaft 216a may include the axis of rotation 216b. The shaft 216a may act as the central axis for rotations of the integrated yokeless rotor 204 rotation. The shaft 216a may be arranged to support the integrated yokeless rotor 204 and to transmit mechanical power to an external system.

According to at least one embodiment of the present invention, the electric machine 200 may further include the end bell 218a-218b. The end bell 218a-218b (FIG. 2) may be an example of the end bell 118a-118b (FIG. 1). The end bell 218a-218b may be adapted to enclose and support one or both ends of the external housing 202.

According to at least one embodiment of the present invention, the electric machine 200 may further include a radial controller 220, an axial controller 222, a first axial controller 222a, a second axial controller 222b, a unified controller 224, a unified axial controller 224a, and a unified stator controller 224b. The radial controller 220 (FIG. 2) may be an example of the radial controller 120 (FIG. 1). The axial controller 222 (FIG. 2) may be an example of the axial controller 122 (FIG. 1). The unified controller 224 (FIG. 2) may be an example of the unified controller 124 (FIG. 1).

The radial controller 220 may be configured to control at least one electrical parameter of the radial stator component 212a. The axial controller 222 may be configured to control at least one electrical parameter of the first axial stator assembly 210a and the second axial stator assembly 210b. The unified controller 224 may be configured to control at least one electrical parameter of the radial stator component 212a, the first axial stator assembly 210a and the second axial stator assembly 210b. The unified controller 224 may further be configured to control the at least one electrical parameter based at least in part on a measured value of the at least one electrical parameter. The unified controller 224 may supervise the radial controller 220 and the axial controller 222. Alternatively, or in addition, the unified controller 224 may incorporate the radial controller 220 and the axial controller 222.

The electrical parameters may be for example, a rotational speed of the integrated yokeless rotor 204, the torque of the electric machine 200, a load condition of the electric machine 200, a current, a voltage, an electric flux, the magnetic flux, and so forth. Embodiments of the present invention may be intended to include or otherwise cover any suitable electrical parameters, including known, related art, and/or later developed technologies, that may be controlled by the radial controller 220, the axial controller 222, and the unified controller 224.

The first axial controller 222a may be configured to control at least one electrical parameter of the first axial stator assembly 210a. The second axial controller 222b may be configured to control at least one electrical parameter of the second axial stator assembly 210b. The unified axial controller 224a may be configured to control at least one electrical parameter of the first axial stator assembly 210a and the second axial stator assembly 210b. The unified stator controller 224b may be configured to control at least one electrical parameter of the radial stator component 212a, the first axial stator assembly 210a, and the second axial stator assembly 210b.

The radial controller 220, the axial controller 222, the first axial controller 222a, the second axial controller 222b, the unified controller 224, the unified axial controller 224a, and the unified stator controller 224b may be a Programmable Logic Control (PLC) unit, a microprocessor, a development board, and so forth. Embodiments of the present invention may be intended to include or otherwise cover any suitable type of the radial controller 220, the axial controller 222, the first axial controller 222a, the second axial controller 222b, the unified controller 224, the unified axial controller 224a, and the unified stator controller 224b, including known, related art, and/or later developed technologies.

According to at least one embodiment of the present invention, the electric machine 200 may further include cold plates 226a-226b. The cold plate 226a may be thermally coupled with the first axial stator assembly 210a, and the cold plate 226b may be arranged in cohesion with the second axial stator assembly 210b. The cold plates 226a-226b may be adapted to modulate a temperature of the first axial stator assembly 210a and the second axial stator assembly 210b by transferring the heat generated during an operation of the first axial stator assembly 210a and the second axial stator assembly 210b to a cooling medium (not shown). The cooling medium may be deposited inside the cold plates 226a-226b, in an embodiment of the present invention. The cooling medium may include a liquid coolant, refrigerants, or air circulated through the cold plates 226a-226b. Embodiments of the present invention may be intended to include or otherwise cover any suitable cooling medium for the first axial stator assembly 210a and the second axial stator assembly 210b, including known, related art, and/or later developed technologies.

In an exemplary embodiment of the present invention, the cold plates 226a-226b may include integrated cooling channels (not shown) to enhance heat transfer efficiency. The cooling channels may be designed to circulate the cooling medium uniformly across a surface area of the cold plates 226a-226b for maintaining a consistent temperature control of the first axial stator assembly 210a and the second axial stator assembly 210b. The cold plates 226a-226b may be fabricated from thermally conductive materials such as aluminum, copper, or composites to optimize thermal conductivity.

The first axial stator assembly 210a and the second axial stator assembly 210b may include additional cooling mechanisms integrated with the cold plates 226a-226b, such as heat sinks, thermoelectric coolers, or forced-air fans, to further enhance the cooling performance of the first axial stator assembly 210a and the second axial stator assembly 210b. Installation of the cold plates 226a-226b in collaboration with the cooling medium and the cooling channels may enable reliable operation of the first axial stator assembly 210a and the second axial stator assembly 210b, even under high power or prolonged operational conditions. Embodiments of the present invention may be intended to include or otherwise cover any suitable cooling mechanisms for the first axial stator assembly 210a and the second axial stator assembly 210b, including known, related art, and/or later developed technologies.

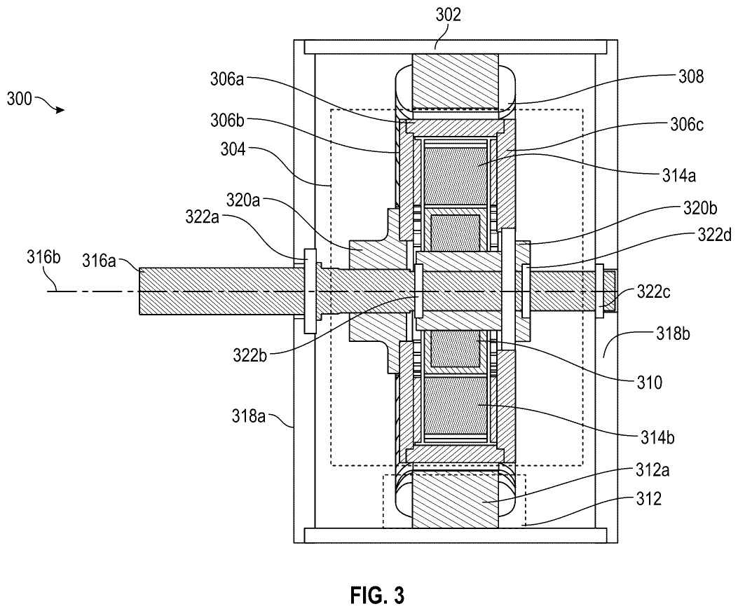

FIG. 3 depicts a cross sectional view of an electric machine 300, according to at least one embodiment of the present invention. The electric machine 300 (FIG. 3) may be an example of the electric machine 100 (FIG. 1) which may be adapted in an inner rotating configuration. The electric machine 300 may be adapted to function similar or nearly similar in some aspects to the electric machine 100 and some of the components of the electric machine 300 may be similar or nearly similar to the components of the electric machine 100.

The electric machine 300 may include an external housing 302, according to at least one embodiment of the present invention. The external housing 302 (FIG. 3) may be an example of the external housing 102 (FIG. 1). According to at least one embodiment of the present invention, the integrated rotor 304 may be arranged inside the external housing 302. The integrated rotor 304 (FIG. 3) may be an example of the integrated rotor 104 (FIG. 1). The integrated rotor 304 may include a radial rotor component 306a, a first axial rotor component 306b, and a second axial rotor component 306c.

The radial rotor component 306a (FIG. 3) may be an example of the radial rotor component 106a (FIG. 1). The first axial rotor component 306b (FIG. 3) may be an example of the first axial rotor component 106b (FIG. 1). The second axial rotor component 306c (FIG. 3) may be an example of the second axial rotor component 106c (FIG. 1). The external housing 302 may further include a radial magnet 308. The radial magnet 308 (FIG. 3) may be an example of the radial magnet 108c (FIG. 1). The radial magnet 308 may be arranged corresponding to the radial rotor component 306a of the integrated rotor 304.

The electric machine 300 may further include a yokeless stator assembly 310 and a radial stator assembly 312, according to at least one embodiment of the present invention. The radial stator assembly 312 may include a radial stator component 312a. The yokeless stator assembly 310 (FIG. 3) may be an example of the yokeless stator assembly 110 (FIG. 1). The radial stator assembly 312 (FIG. 3) may be an example of the radial stator assembly 112 (FIG. 1). The radial stator component 312a (FIG. 3) may be an example of the radial stator component 112a (FIG. 1). Plurality of windings 314a-314b, may be wrapped around the yokeless stator assembly 310, may be adapted to generate the magnetic fields. The plurality of windings 314a-314 (FIG. 3) may be an example of the plurality of windings 114a-114 (FIG. 1).

According to at least one embodiment of the present invention, the electric machine 300 may include a shaft 316a that may be positioned at the center of the electric machine 300. The shaft 316a (FIG. 3) may be an example of the shaft 116a (FIG. 1). The shaft 316a may be adapted to rotate at an axis of rotation 316b.

The shaft 316a may be a rotating component of the electric machine 300, however, an end bell 318a-318b may be a stationary component of the electric machine 300. The end bell 318a-318b (FIG. 3) may be an example of the end bell 118a-118b (FIG. 1). Further, to establish an accommodation between the rotating component and the stationary component of the electric machine 300, packings 320a-320b and bearings 322a-322d may be installed in a preset sequence.

The preset sequence may be as, the bearing 322a may be installed in an inner periphery of the end bell 318a. Similarly, the bearing 322b may be installed in the inner periphery of the end bell 318b. Further, the bearings 322c-322d may be installed on the shaft 316a. Further, the bearing 322b may be inserted into the packing 320b, and the shaft 316a may be inserted into the packing 320b. Insertion of the shaft 316a in the packing 320b may automatedly align and insert the shaft 316a into the bearings 322b and the bearing 322d. Upon insertion of the shaft 316a into the packing 320b, the shaft 316a may be manually rotated to check a rotational freedom of the shaft 316a into the packing 320b. Furthermore, the packing 320a may be installed on the shaft 316a preinstalled with the bearing 322b. Furthermore, the end bell 318a, having the bearing 322a, may be installed on the shaft 316a. The installation of the packings 320a-320b on the shaft 316a, and further the installation of the bearings 322a-322d between the packings 320a-320b and the end-bell 318a-318b may provide a resistance less and friction free rotation of the shaft 316a in the electric machine 300.

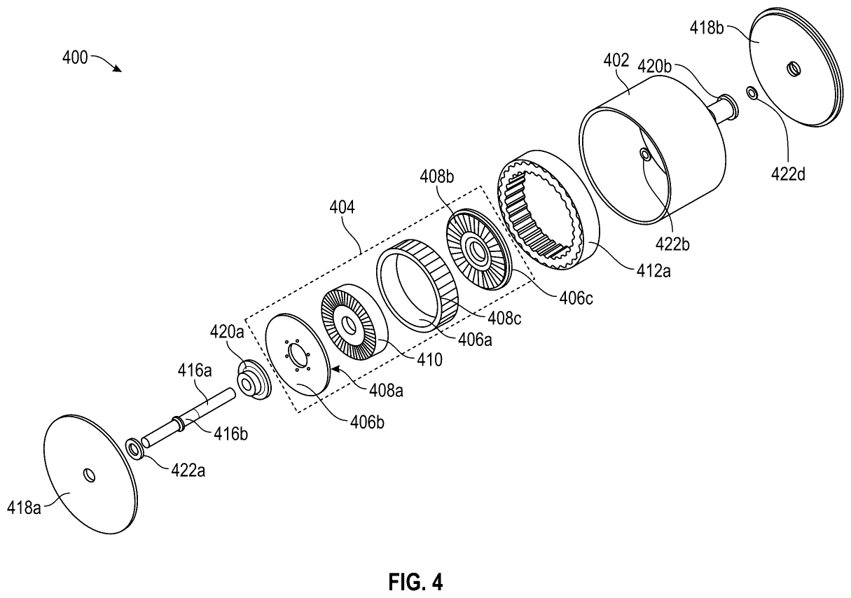

FIG. 4 depicts an exploded view of an electric machine 400, according to at least one embodiment of the present invention. The electric machine 400 (FIG. 4) may be an example of the electric machine 100 (FIG. 1) which may be adapted in the inner rotating configuration. The electric machine 400 may be adapted to function similar or nearly similar in some aspects to the electric machine 100 and some of the components of the electric machine 400 may be similar or nearly similar to the components of the electric machine 100.

The electric machine 400 may include an external housing 402, according to at least one embodiment of the present invention. The external housing 402 (FIG. 4) may be an example of the external housing 102 (FIG. 1).

According to at least one embodiment of the present invention, an integrated rotor 404 may be arranged inside the external housing 402. The integrated rotor 404 (FIG. 4) may be an example of the integrated rotor 104 (FIG. 1). The integrated rotor 404 may include a radial rotor component 406a, a first axial rotor component 406b, and a second axial rotor component 406c.

The radial rotor component 406a (FIG. 4) may be an example of the radial rotor component 106a (FIG. 1). The first axial rotor component 406b (FIG. 4) may be an example of the first axial rotor component 106b (FIG. 1). The second axial rotor component 406c (FIG. 4) may be an example of the second axial rotor component 106c (FIG. 1). The external housing 402 may further include a first stator pole 408a, a second stator pole 408b, and a radial magnet 408c. The first stator pole 408a may be an example of the first stator pole 108a (FIG. 1). The second stator pole 408b may be an example of the second stator pole 108b (FIG. 1). The radial magnet 408c (FIG. 4) may be an example of the radial magnet 108c (FIG. 1).

The first stator pole 408a may be arranged corresponding to the first axial rotor component 406b of the integrated rotor 404. The second stator pole 408b may be arranged corresponding to the second axial rotor component 406c of the integrated rotor 404. The radial magnet 408c may be arranged corresponding to the radial rotor component 406a of the integrated rotor 404.

The electric machine 400 may further include a yokeless stator assembly 410 and a radial stator assembly 412, according to at least one embodiment of the present invention. The radial stator assembly 412 may include a radial stator component 412a. The yokeless stator assembly 410 (FIG. 4) may be an example of the yokeless stator assembly 110 (FIG. 1). The radial stator assembly 412 (FIG. 4) may be an example of the radial stator assembly 112 (FIG. 1). The radial stator component 412a (FIG. 4) may be an example of the radial stator component 112a (FIG. 1).

The radial rotor component 406a, the first axial rotor component 406b, and the second axial rotor component 406c of the integrated rotor 404 may be configured to magnetically interact with the stator assembly. The radial rotor component 406a may be configured to magnetically interact with the radial stator component 412a of the stator assembly. The first axial rotor component 406b, and the second axial rotor component 406c may be configured to magnetically interact with yokeless stator assembly 410 of the stator assembly.

The integrated rotor 404 may be disposed with respect to the stator assembly in a predefined configuration to define a relative positioning of the integrated rotor 404 and the stator assembly. The predefined configuration may be an inner rotating configuration of the integrated rotor 404. The inner rotating configuration may incorporate the yokeless stator assembly 410 of the stator assembly that may be arranged inside the integrated rotor 404. Further, in the inner rotating configuration, the radial stator component 412a of the stator assembly may be positioned along a length of the integrated rotor 404 situated at one or both ends of the integrated rotor 404.

The yokeless stator assembly 410 of the stator assembly may be arranged to face at least one flat surface of the integrated rotor 404 to generate an axial magnetic field (e.g., a magnetic field interacting with one or more axial rotor components). The radial stator component 412a of the stator assembly may be arranged concentrically with an axis of rotation 416b of the integrated rotor 404 to generate a radial magnetic field (e.g., a magnetic field interacting with one or more radial rotor components). Further, the yokeless stator assembly 410 and the radial stator component 412a of the radial stator assembly 412, may be configured with the respective plurality of windings 414a-414b for corresponding of the yokeless stator assembly 410 and the radial stator component 412a.

Further, in the inner rotating configuration, the integrated rotor 404 may be positioned outside the stator assembly. In an exemplary embodiment of the present invention, in the inner rotating configuration, the yokeless stator assembly 410 may be positioned inside the integrated rotor 404 and may include a plurality of windings 414a-414b that may generate the magnetic fields. The plurality of windings 414a-414b (FIG. 4) may be an example of the plurality of windings 114a-114b (FIG. 1).

According to at least one embodiment of the present invention, the electric machine 400 may include a shaft 416a that may be positioned at the center of the electric machine 400. The shaft 416a (FIG. 4) may be an example of the shaft 116a (FIG. 1). The shaft 416a may be adapted to rotate along the axis of rotation 416b.

The yokeless stator assembly 410 may be arranged around a cylindrical surface of the integrated rotor 404 and may be disposed between the radial rotor component 406a of the integrated rotor 404 and end bell 418a-418b of the electric machine 400, according to at least one embodiment of the present invention. The end bell 418a-418b (FIG. 4) may be an example of the end bell 118a-118b (FIG. 1).

The shaft 416a may be a rotating component of the electric machine 400, however, the end bell 418a-418b may be a stationary component of the electric machine 400. Further, to establish an accommodation between the rotating component and the stationary component of the electric machine 400, packings 420a-420b and bearings 422a-422d may be installed in a preset sequence in collaboration with the shaft 416a and the end bell 418a-418b. The packings 420a-420b (FIG. 4) may be an example of the packings 320a-320b (FIG. 3). The bearings 422a-422d (FIG. 4) may be an example of the bearings 322a-322d (FIG. 3).

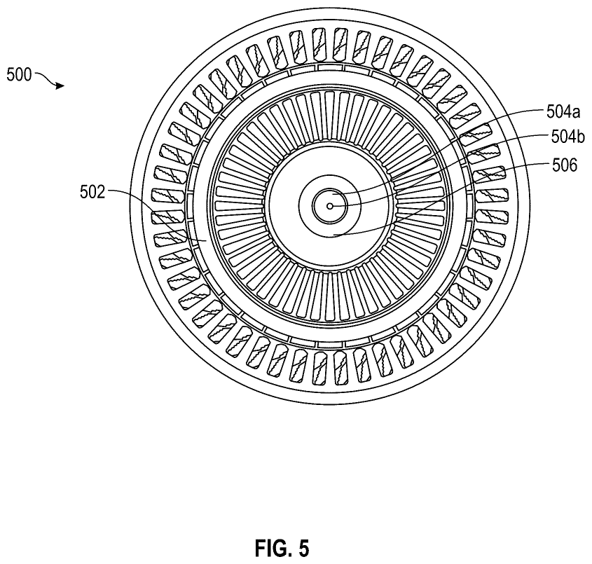

FIG. 5 depicts a side view of a yokeless stator assembly 500, according to at least one embodiment of the present invention. The yokeless stator assembly 500 (FIG. 5) may be an example of the yokeless stator assembly 110 (FIG. 1). The yokeless stator assembly 500 may comprise a plurality of windings 502. The plurality of windings 502 (FIG. 5) may be an example of the plurality of windings 114a-114b (FIG. 1). A shaft 504a may pass through the yokeless stator assembly 500. The shaft 504a (FIG. 5) may be an example of the shaft 116a (FIG. 1). Further, the shaft 504a may be held in place by packings 506. The packings 506 (FIG. 5) may be an example of the packings 320a-320b (FIG. 3). The shaft 504a may further be adapted to rotate on an axis of rotation 504b.

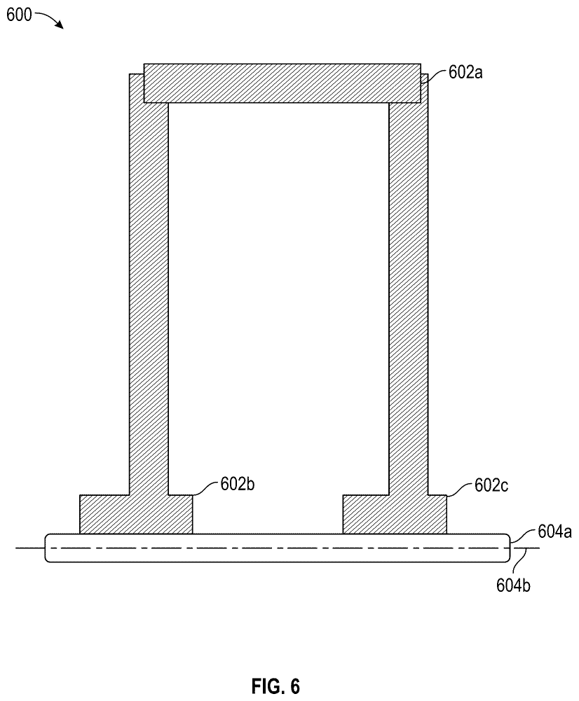

FIG. 6 depicts an integrated rotor 600, according to at least one embodiment of the present invention. The integrated rotor 600 (FIG. 6) may be an example of the integrated rotor 104 (FIG. 1). The integrated rotor 600 may include a radial rotor component 602a. The radial rotor component 602a (FIG. 6) may be an example of the radial rotor component 106a (FIG. 1). The radial rotor component 602a may be arranged substantially parallel to a shaft 604a, thus parallel to an axis of rotation 604b. The shaft 604a (FIG. 6) may be an example of the shaft 116a (FIG. 1). The integrated rotor 600 may further include an axial rotor component 602b-602c. The axial rotor component 602b-602c (FIG. 6) may be an example of the axial rotor component 106b-106c (FIG. 1). The axial rotor component 602b-602c may be arranged substantially perpendicular to the shaft 604a, and/or the axis of rotation 604b.

The axial rotor component 602b-602c may be arranged at an angle such as, but not limited to, less than 0.5 degrees, less than 1.0 degrees, less than 2 degrees, less than 5 degrees, less than 10 degrees, less than 20 degrees, less than 45 degrees, less than 60 degrees, and so forth from the perpendicular. Embodiments of the present invention are intended to include or otherwise cover any suitable angle for arrangement of the axial rotor component 602b-602c with the shaft 604a, and/or the axis of rotation 604b.

The axial rotor component 602b-602c may be mechanically integrated with the radial rotor component 602a. The mechanical integration of the axial rotor component 602b-602c with the radial rotor component 602a may maintain a common angular velocity between the axial rotor component 602b-602c and the radial rotor component 602a. In practice, components of the integrated rotor 600 may not be perfectly rigid so that angular velocity may vary slightly during acceleration or deceleration (e.g., a variance of less than 1%) of the radial rotor component 602a and/or the axial rotor component 602b-602c. Controllers (not shown) may be configured to limit such variance and/or corresponding stresses in rotor components.

Although not shown in FIG. 6, the electric machine may include one or more axial controllers (not shown) for the axial rotor component 602b-602c, one or more radial controllers (not shown) for the radial rotor component 602a and/or a unified controller (not shown) for both the radial rotor component 602a and the axial rotor component 602b-602c. In at least one embodiment of the present invention, the unified controller may supervise the individual axial controllers and the radial controllers.

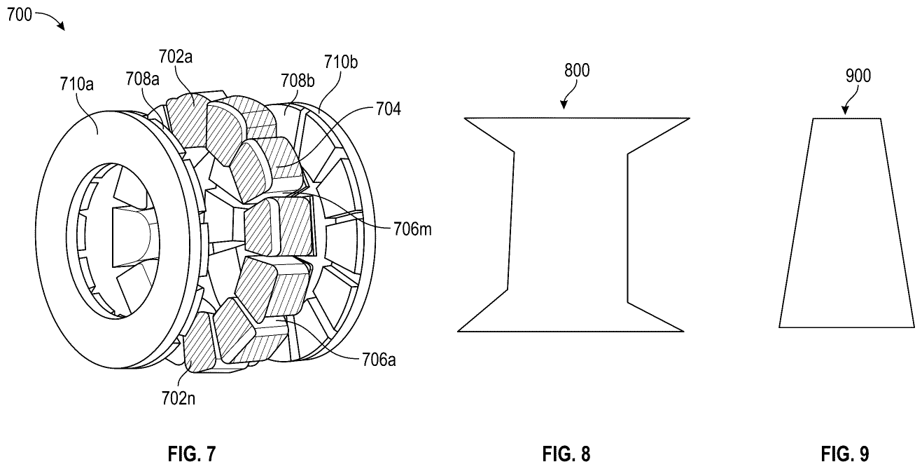

FIG. 7 depicts a yokeless stator assembly 700, according to at least one embodiment of the present invention. The yokeless stator assembly 700 (FIG. 7) may be an example of the yokeless stator assembly 110 (FIG. 1).

According to at least one embodiment of the present invention, the yokeless stator assembly 700 may include stator slots 702a-702n (hereinafter also collectively referred to as the stator slots 702, or individually referred to as the stator slot 702). The stator slots 702 may receive conductive windings 704.

The windings 704 (FIG. 7) may be an example of the plurality of windings 114a-114b (FIG. 1). The windings 704 may enable an induction of magnetic flux in the yokeless stator assembly 700. The magnetic flux may be induced by magnetic fields developed with a first stator pole 708a and a second stator pole 708b. The first stator pole 708a (FIG. 7) may be an example of the first stator pole 108a (FIG. 1). The second stator pole 708b (FIG. 7) may be an example of the second stator pole 108b (FIG. 1). The magnetic fields developed with the first stator pole 708a and the second stator pole 708b may pass through the windings 704 on the yokeless stator assembly 700 for induction of the magnetic flux in the yokeless stator assembly 700. As one example, the stator slots 702 of the yokeless stator assembly 700 may include 40% winding volume and 60% lamination cross-section. Embodiments of the present invention may be intended to include or otherwise cover any suitable percentage of the winding volume and the lamination cross-section in the stator slots 702 of the yokeless stator assembly 700.

Further, a number of the stator slots 702 per the first stator pole 708a and the second stator pole 708b may be a non-integer value. This configuration may enable that the windings 704 of the stator slots 702 may effectively and/or efficiently interact with the magnetic fields of the first stator pole 708a and the second stator pole 708b for the development of magnetic flux.

In an exemplary scenario of the present invention, if the total number of the stator slots 702 is equal to the total number of the first stator pole 708a and the second stator pole 708b, then in such cases, the stator slots 702 may tend to align with the first stator pole 708a and the second stator pole 708b. The alignment of the first stator pole 708a and the second stator pole 708b with the stator slots 702 may attenuate the passage of the magnetic fields through the windings 704. Hence, there may be reduced achievement of changes in the magnetic field in the windings 704 leading to deterioration of the magnetic flux in the yokeless stator assembly 700.

Similarly, in another scenario of the present invention, where the total number of the stator slots 702 is unequal to the total number of the first stator pole 708a and the second stator pole 708b, then in such cases, there may be at least one stator slot 702 that may be sharing the first stator pole 708a and the second stator pole 708b with another stator slot 702. The sharing of the first stator pole 708a and the second stator pole 708b may allow the passage of the magnetic field lines through the windings 704. Hence, there may be changes in the magnetic field leading to the development of magnetic flux in the yokeless stator assembly 700.

According to at least one embodiment of the present invention, the yokeless stator assembly 700 may include cooling gaps 706a-706m (hereinafter collectively referred to as the cooling gaps 706, or individually referred to as the cooling gap 706). The cooling gaps 706 may be positioned adjacent to one or more of, the stator slots 702 and the windings 704 to facilitate efficient heat dissipation.

The cooling gaps 706 may be thermally coupled with the windings 704 and configured to transfer heat generated during operation of the yokeless stator assembly 700 to a cooling medium (not shown). The cooling medium may be deposited in the cooling gaps 706, in an embodiment of the present invention. The cooling medium may include a liquid coolant, refrigerants, or air circulated through the cooling gaps 706. Embodiments of the present invention may be intended to include or otherwise cover any suitable cooling medium for the yokeless stator assembly 700, including known, related art, and/or later developed technologies.

In an exemplary embodiment of the present invention, the cooling gaps 706 may include integrated cooling channels (not shown) to enhance heat transfer efficiency. The cooling channels may be designed to circulate the cooling medium uniformly across a surface area of the cooling gaps 706 for maintaining a consistent temperature control of the yokeless stator assembly 700. The cooling gaps 706 may be fabricated from thermally conductive materials such as aluminum, copper, or composites to optimize thermal conductivity.

The yokeless stator assembly 700 may include additional cooling mechanisms integrated with the cooling gaps 706, such as heat sinks, thermoelectric coolers, or forced-air fans, to further enhance the cooling performance of the yokeless stator assembly 700, a first axial rotor component 710a, and a second axial rotor component 710b. The first axial rotor component 710a (FIG. 7) may be an example of the first axial rotor component 106b (FIG. 1). The second axial rotor component 710b (FIG. 7) may be an example of the second axial rotor component 106c (FIG. 1).

Installation of the cooling gaps 706 in collaboration with the cooling medium and the cooling channels may enable reliable operation of the yokeless stator assembly 700, even under high power or prolonged operational conditions. Embodiments of the present invention may be intended to include or otherwise cover any suitable cooling mechanisms for the yokeless stator assembly 700, including known, related art, and/or later developed technologies.

FIG. 8 depicts a side view of stator slots 800 of a yokeless stator (e.g., the yokeless stator 700 of the FIG. 7), according to at least one embodiment of the present invention. The stator slots 800 may be designed to optimize (e.g., maximize) an electromagnetic performance, for example, by minimizing flux leakage and improving thermal management.

FIG. 9 depicts a top view of stator slots 900 of a yokeless stator (e.g., the yokeless stator 700 of the FIG. 7), according to at least one embodiment of the present invention. The stator slots 900 may be designed to optimize (e.g., maximize) an electromagnetic performance, for example, by minimizing flux leakage and improving thermal management.

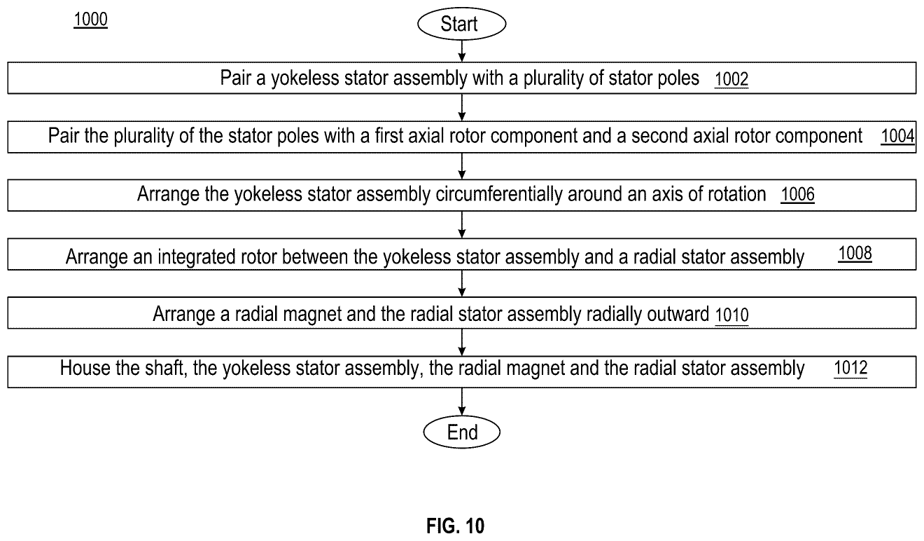

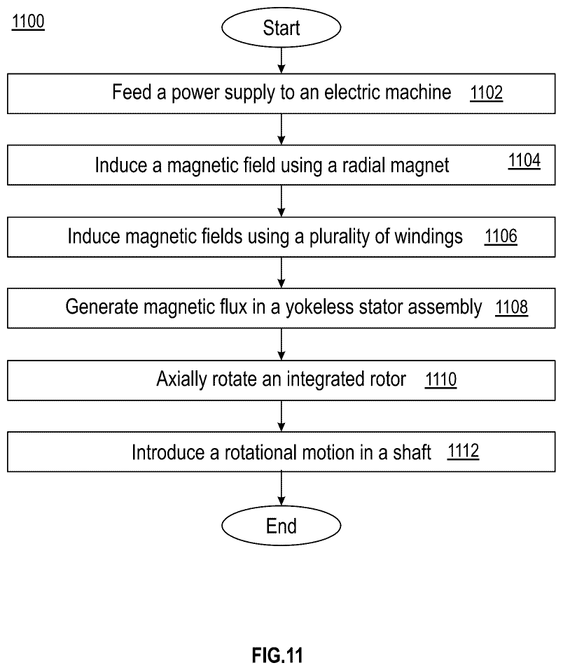

FIGS. 10-11 depict illustrative one or more processes 1000-1100 for assembling and operating the electric machine 100 in accordance with at least one embodiment of the present invention. It is to be understood that the processes 1000-1100, as illustrated in the FIGS. 10-11, may be described in accordance with at least one embodiment of the present invention without direct reference to specific numerals of the components depicted corresponding to the electric machine 100 (FIG. 1), or the electric machine 200 (FIG. 2), or the electric machine 300 (FIG. 3), or the electric machine 400 (FIG. 4). The omission of specific numerals for components in describing the processes 1000-1100 are not intended to limit the scope of the invention, and the processes 1000-1100 may be implemented using any suitable configuration or arrangement of the components described in the electric machine 100 (FIG. 1), or the electric machine 200 (FIG. 2), or the electric machine 300 (FIG. 3), or the electric machine 400 (FIG. 4).

The one or more processes 1000-1100 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any suitable number of the described blocks may be combined in any suitable order and/or in parallel to implement the process.

FIG. 10 depicts an exemplary process 1000 for assembling an electric machine, according to embodiments of the present invention.

At 1002 block, the yokeless stator assembly may be parallelly paired with the plurality of the windings.

At 1004 block, the plurality of the stator poles may be parallelly paired with the first axial rotor component and the second axial rotor component of the integrated rotor.

At 1006 block, the yokeless stator assembly with the windings may be arranged circumferentially around the axis of rotation, and may be disposed between the first axial rotor component and the second axial rotor component.

At 1008 block, the integrated rotor may be disposed between the yokeless stator assembly and the radial stator assembly.

At 1010 block, the radial magnet and the radial stator assembly may be arranged radially outward from the radial rotor component of the integrated rotor.

At 1012 block, the combination of the shaft, the yokeless stator assembly, the radial magnet, and the radial stator assembly may be housed in the external housing, achieving the assembled electric machine.

FIG. 11 depicts an exemplary process 1100 for operating an electric machine, according to embodiments of the present invention.

At block 1102, the electric machine may be fed with a power supply. The power supplied may activate the radial controller, the axial controller, the first axial controller, the second axial controller, the unified axial controller, the unified stator controller, the unified controller, and/or other electrical and/or electronic components of the assembled electric machine including windings.

At block 1104, a radial magnet may induce a magnetic field.

At block 1106, the plurality of the windings may induce one or more magnetic fields.

At block 1108, the yokeless stator assembly may generate a magnetic flux.

At block 1110, the integrated rotor may rotate axially due to the generated magnetic flux.

At block 1112, the axial rotation in the integrated rotor may introduce a rotational motion in the shaft.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electric machine, comprising:
a shaft having an axis of rotation;
an integrated rotor mechanically coupled with the shaft, the integrated rotor comprising a first axial rotor component arranged substantially perpendicular to the axis of rotation, a second axial rotor component arranged substantially perpendicular to the axis of rotation and a radial rotor component arranged substantially parallel to the axis of rotation;
a yokeless stator assembly disposed between the first axial rotor component and the second axial rotor component, the yokeless stator assembly configured to magnetically interact with the first axial rotor component and the second axial rotor component; and
a radial stator assembly comprising a radial stator component arranged substantially parallel to the axis of rotation, the radial stator assembly configured to magnetically interact with the radial rotor component.

2. The electric machine of claim 1, wherein the first axial rotor component is arranged at a first angle from the perpendicular to the axis of rotation and the second axial rotor component is arranged at a second angle from the perpendicular to the axis of rotation.

3. The electric machine of claim 2, wherein the first angle and the second angle are greater than 0 degrees and less than 60 degrees.

4. The electric machine of claim 1, further comprising:
a radial controller configured to control at least one electrical parameter of the radial stator component; and
an axial controller configured to control at least one electrical parameter of the yokeless stator assembly.

5. The electric machine of claim 1, further comprising a unified controller configured to control at least one electrical parameter of the radial stator component and the yokeless stator assembly.

6. The electric machine of claim 5, wherein the unified controller is configured to control the at least one electrical parameter based at least in part on a measured value of the at least one electrical parameter.

7. The electric machine of claim 5, wherein the unified controller is configured to control the at least one electrical parameter based at least in part on a measured value of one or more of: a rotational speed of the integrated rotor, a torque of the electric machine and a load condition of the electric machine.

8. The electric machine of claim 1, further comprising a radial magnet disposed between the radial rotor component and the radial stator assembly, wherein the radial magnet comprises a rare earth magnet material.

9. The electric machine of claim 1, wherein a number of stator slots per magnetic pole is a non-integer value.

10. An electric machine, comprising:
a shaft having an axis of rotation;
an integrated yokeless rotor mechanically coupled with the shaft, the integrated yokeless rotor comprising an axial rotor component arranged substantially perpendicular to the axis of rotation and a radial rotor component arranged substantially parallel to the axis of rotation;
a first axial stator assembly arranged substantially perpendicular to the axis of rotation, the first axial stator assembly configured to magnetically interact with the axial rotor component;
a second axial stator assembly arranged substantially perpendicular to the axis of rotation, the second axial stator assembly configured to magnetically interact with the axial rotor component, wherein the axial rotor component is disposed between the first axial stator assembly and the second axial stator assembly; and
a radial stator assembly comprising a radial stator component arranged substantially parallel to the axis of rotation, the radial stator assembly configured to magnetically interact with the radial rotor component.

11. The electric machine of claim 10, wherein the radial rotor component instead comprises a first radial rotor component arranged at a first angle from the parallel to the axis of rotation and a second radial rotor component arranged at a second angle from the parallel to the axis of rotation.

12. The electric machine of claim 11, wherein the first angle and the second angle are greater than 0 degrees and less than 60 degrees.

13. The electric machine of claim 10, further comprising:
a radial controller configured to control at least one electrical parameter of the radial stator component;
a first axial controller configured to control at least one electrical parameter of the first axial stator assembly; and
a second axial controller configured to control at least one electrical parameter of the second axial stator assembly.

14. The electric machine of claim 10, further comprising:
a radial controller configured to control at least one electrical parameter of the radial stator component; and
a unified axial controller configured to control at least one electrical parameter of the first axial stator assembly and the second axial stator assembly.

15. The electric machine of claim 10, further comprising a unified stator controller configured to control at least one electrical parameter of the radial stator component, the first axial stator assembly and the second axial stator assembly.

16. The electric machine of claim 10, wherein the unified controller is configured to control the at least one electrical parameter based at least in part on a measured value of one or more of: at least one electrical parameter, a rotational speed of the integrated yokeless rotor, a torque of the electric machine and a load condition of the electric machine.

17. The electric machine of claim 10, further comprising a radial magnet disposed between the radial rotor component and the radial stator assembly, wherein the radial magnet comprises a rare earth magnet material.

18. The electric machine of claim 10, wherein a number of stator slots per magnetic pole is a non-integer value.

19. An apparatus, comprising:
a shaft having an axis of rotation;
an integrated rotor mechanically coupled with the shaft, the integrated rotor comprising at least one axial rotor component arranged substantially perpendicular to the axis of rotation and a radial rotor component arranged substantially parallel to the axis of rotation, wherein the at least one axial rotor component is mechanically integrated with the radial rotor component such that the at least one axial rotor component and the radial rotor component have a common angular velocity; and
a stator assembly configured at least to magnetically interact with the at least one axial rotor component and the radial rotor component.

20. The apparatus of claim 19, wherein the stator assembly comprises a yokeless stator assembly.
